(19) United States
(12) Patent Application Publication
(10) Pub. No.: US 2014/0091621 A1
(43) Pub. Date: Apr. 3, 2014

(54) STRUCTURE AND METHOD FOR PROVIDING POWER TO EXTERNAL MOBILE DEVICES

(71) Applicants: YUAN-SHAN HSU, New Taipei City (TW); WEN-HSIANG HSIAO, Taipei City (TW); KUANG-FENG LIN, Keelung City (TW)

(72) Inventors: YUAN-SHAN HSU, New Taipei City (TW); WEN-HSIANG HSIAO, Taipei City (TW); KUANG-FENG LIN, Keelung City (TW)

(21) Appl. No.: 13/680,494

(22) Filed: Nov. 19, 2012

(30) Foreign Application Priority Data
Sep. 28, 2012 (TW) 101135837

(51) Int. Cl. H02J 1/00

(52) U.S. Cl. CPC H02J 1/00
USPC 307/18; 307/43

(57) ABSTRACT

A structure for providing power to external mobile devices has a first power supply module and a second power supply module. The first power supply module has a first voltage source outputting an activation current to a main circuit of an external mobile device when activated. The second power supply module has a first boost circuit and an activation circuit. A second voltage source from a computer supplies power to the first boost circuit through the first boost circuit to output a first operating current to the main circuit through the activation circuit to replace the activation current supplied from the first power supply module. The structure further has a blocking circuit blocking the first voltage source to keep supplying power for the purpose of energy conservation and carbon reduction when the external mobile device is powered off.

### BACKGROUND OF THE INVENTION

1. Field of the Invention

The present invention relates to a device and a method for providing power to external mobile devices and more particularly to a device using a DC battery to activate a 3.5 inch hard drive or a CD/DVD drive of an external mobile device, further getting power from the VBUS pin of a USB port of a desktop computer or a notebook computer, and boosting the power into an operating power through a boost circuit to the 3.5 inch hard drive or the CD/DVD drive of the external mobile device without requiring any other external power supply.

2. Description of the Related Art

Mobile devices, such as notebook computers, tablet personal computers, ultrabook computers and the like, have widely penetrated into all walks of life in recent years. Due to limited built-in memory capacity of these mobile devices, most users require an additional external hard drive to store or back up digital data and such demand gives rise to significant growth of market demand for external hard drives.

However, to ensure satisfactory transmission performance and smooth data access when a hard drive is accessing a huge amount of files, the hard drive needs to be upgraded in terms of its specification level. Especially for a 3.5 inch hard drive with a high-speed motor, at least one 12V/2 A or 12V/1 A power supply is required to drive the motor. Such a hard drive thus inevitably has a limited portability. Accordingly, how to make such a high-speed hard drive becomes a real portable device that lives up to its name is a subject needing to be solved by manufacturers of the high-speed hard drives.

### SUMMARY OF THE INVENTION

In view of the drawbacks of the conventional means for providing power to external mobile devices, the present invention is designed based on innovative concepts conceived according to years of experience involving study in many related fields, prototype building practice and numerous modifications.

An objective of the present invention is to provide a structure and a method for providing power to external mobile devices.

To achieve the foregoing objective, the structure for providing power to external mobile devices has a first power supply module and a second power supply module.

The first power supply module has a first voltage source or/and a second boost circuit.

The first voltage source outputted a power with an activation current to a main circuit connected to an external mobile device.

The second power supply module has an activation circuit and a first boost circuit.

The boost circuit is electrically connected to the activation circuit, is adapted to receive and boost a second outputted voltage outputted from a second voltage source, and outputted a first operating current for replacing the activation current to supply power to the main circuit through the activation circuit.

Given the first power supply module inside an external mobile device, the second voltage source can outputted power to the activation circuit to replace the activation current from the first power supply module for supplying an operating power to the main circuit in the external mobile device. In that sense, a DC rechargeable battery is the only power required to drive a 3.5 inch hard drive or a CD/DVD drive inside the external mobile device for stable data access and data recording operations thereof without using power from any power outlet or from any other power supply to achieve real portability as intended. After an external mobile device is connected with a computer device, a 3.5 inch hard drive inside the external mobile device just needs the power supplied from the computer device for operation of the external mobile device and data access of the hard drive instead of being activated or operated by power from any other external power supply or transformer.

Moreover, the first power supply module of the structure for providing power to external mobile devices provided by the present invention further has a blocking circuit serving to block the first power supply module to supply power when the external mobile device is powered off and the second power supply module stops supplying power at the same time, thereby significantly reducing energy waste and attaining the effect of energy conservation and carbon reduction.

### BRIEF DESCRIPTION OF THE DRAWINGS

FIG. 1 is a functional block diagram of a first embodiment of a structure for providing power to external mobile devices in accordance with the present invention;

FIG. 2 is a schematic perspective view of a structure for providing power to external mobile devices in accordance with the present invention applied to an external mobile device;

FIG. 3 is a functional block diagram of a second embodiment of a structure for providing power to external mobile devices in accordance with the present invention;

FIG. 4 is a functional block diagram of a third embodiment of a structure for providing power to external mobile devices in accordance with the present invention;

FIG. 5 is a functional block diagram of a fourth embodiment of a structure for providing power to external mobile devices in accordance with the present invention;

FIG. 6 is a flow diagram of a first embodiment of a method for providing power to external mobile devices in accordance with the present invention;

FIG. 7 is a flow diagram of a second embodiment of a method for providing power to external mobile devices in accordance with the present invention; and

FIG. 8 is a flow diagram of a third embodiment of a method for providing power to external mobile devices in accordance with the present invention.

### DETAILED DESCRIPTION OF THE INVENTION

The present invention discloses a structure for providing power to external mobile devices. As known to persons who have ordinary skill in the related technical field of the present invention, the concepts adopted by the present invention in association with the operation of hard drives, data access and electronic circuit loops among all related devices are therefore not repeated in the following description. Further, instead of being drawn according to actual scales, the drawings of the present invention mentioned in the following description are dedicated to illustrate the structure pertinent to the characteristics of the present invention.

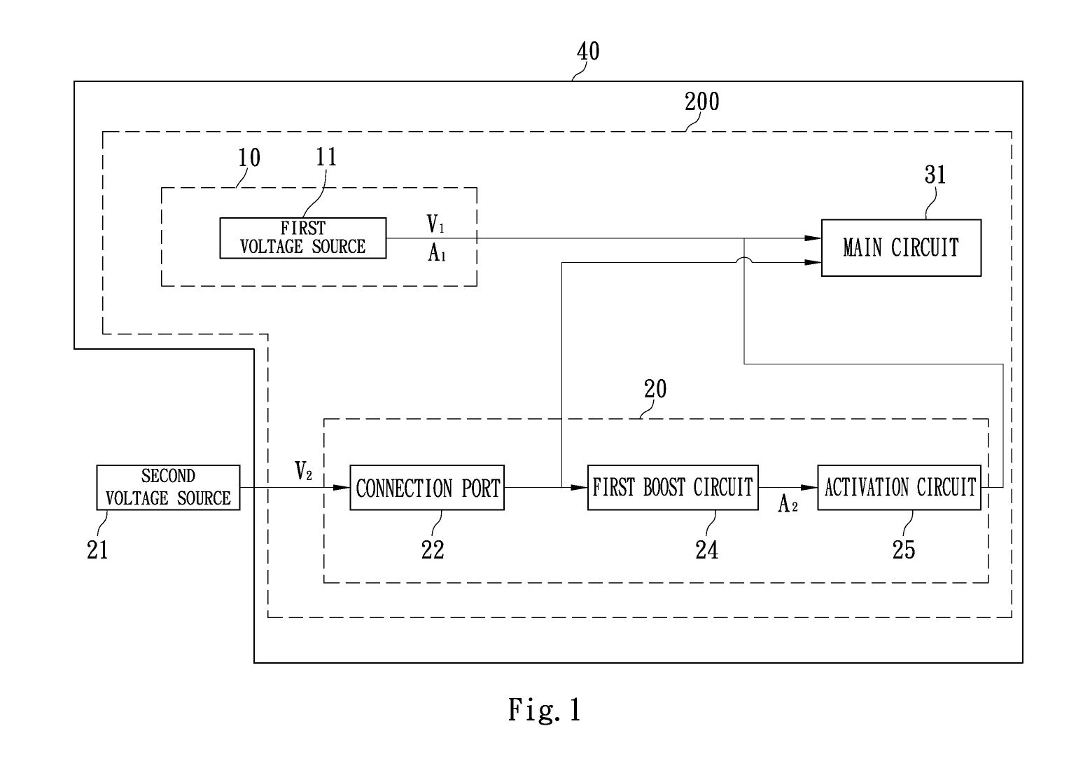

With reference to FIG. 1, a first embodiment of a structure 200 for providing power to external mobile devices in accordance with the present invention has a first power supply module 10 and a second power supply module 20. The external mobile device 40 driven by the structure 200 may accommodate an external hard drive (in particular a 3.5 inch hard drive), a CD/DVD drive or the like.

The first power supply module 10 has a first voltage source 11. The first voltage source 11 may be a rechargeable DC battery, such as a lithium battery, a nickel-metal hydride battery, a lithium iron phosphate battery or the like, and outputs a power with a first output voltage V₁ and an activation current A₁. The first output voltage V₁ is a DC voltage and ranges from 11.1V to 11.7V and the activation current A₁ falls in a range of 3 A to 5 A so that a hard drive (in particular a 3.5 inch hard drive) received in the external mobile device 40 can be activated by the first voltage source 11.

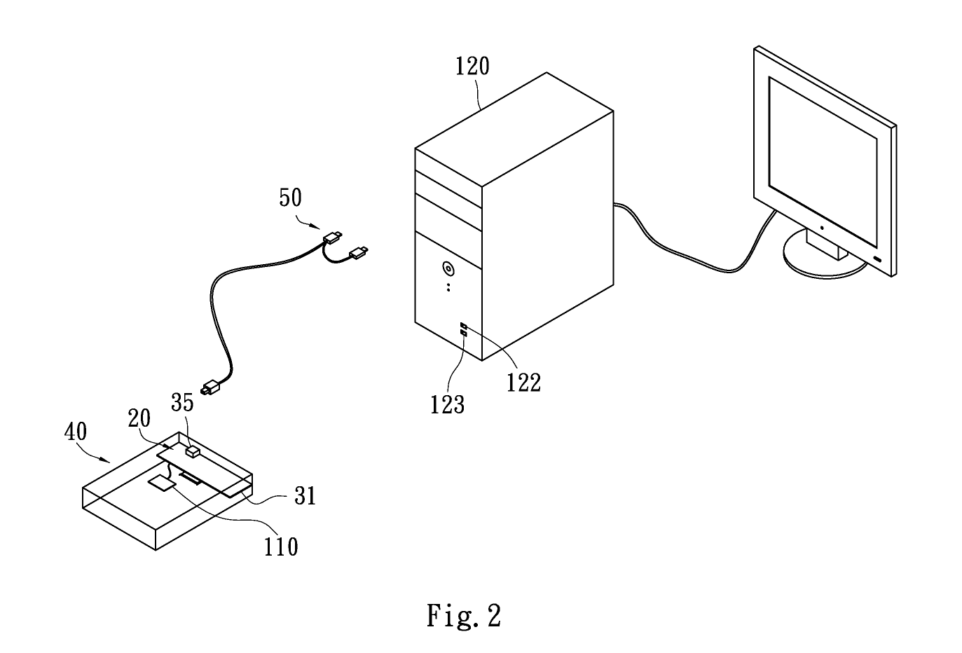

The second power supply module 20 has a second voltage source 21, a first boost circuit 24 and an activation circuit 25. The second voltage source 21 supplies power to the first boost circuit 24 from a first interface output port 122 and a second interface output port 123 of a computer device 120 as shown in FIG. 2 and through a USB Y-shaped transmission line 50 so as to output a second output voltage V₂ to a connection port 22 on the second power supply module. The connection port 22 is a USB port and is electrically connected to the first boost circuit 24. The second output voltage V₂ is outputted to the first boost circuit 24 and is boosted so that the boosted voltage falls in a range of 11.7V to 12.58V. The first boost circuit 24 is electrically connected to the activation circuit 25 to transmit the boosted voltage to the activation circuit 25. The activation circuit 25 is further electrically connected to a main circuit 31 of the external mobile device 40 so that the activation circuit 25 stably supplies power to the hard drive or CD/DVD drive inside the external mobile device using the second output voltage V₂ to replace the activation current A₁ outputted from the first power supply module 10.

With reference to FIGS. 1 and 2, a physical implementation of a structure for providing power to external mobile device having the foregoing elements is shown. The external mobile device 40 has the main circuit 31 and the structure for providing power to external mobile devices 200. The main circuit 31 is electrically connected to the first power supply module 10 and the second power supply module 20 of the power-driving structure 200. By transmitting an activation signal to the main circuit 31 through the connection port 22, the first voltage source 11 inside the external mobile device 40 outputs a current (a high transient load current) to the main circuit 31 so as to activate the hard drive or the CD/DVD drive inside the external mobile device 40. The second voltage source 21 of the second power supply module 20 in the computer device 120 supplies power to the USB connection port 22 through the USB transmission line 50. The second voltage source 21 outputs the second output voltage V₂ to the first boost circuit 24. The second output voltage V₂ is boosted by the first boost circuit 24 to output a first operating current A₂ or a voltage in a range of 11.7V to 12.58V. The first operating current A₂ is further transmitted to the activation circuit 25 to replace the activation current A₁ outputted from the first power supply module 10 for the purpose of performing a data access operation of the hard drive or CD/DVD drive in the external mobile device 40 connected to the main circuit 31 and charging the first voltage source 11. The structure 200 for providing power to external mobile devices disclosed by the present invention has a rechargeable DC battery 110 mounted inside the external mobile device 40 and thus does not require power from an external power outlet or use a 12V power supply, so as to actually ensure its portability. All the structure 200 needs the USB Y-shaped transmission line 50, which is commonly carried with the structure 200, rendering more portability and operational convenience to the structure 200. The rechargeable DC battery 110 can be repeatedly charged and operated and has higher level of environmental protection relative to the disposable batteries for one-time use. Furthermore, DC power may be supplied to the first boost circuit 24 to drive the 3.5 inch hard drive or the DC/DVD drive inside the external mobile device for stable operation, thereby saving more power and achieving the effect of carbon reduction. Additionally, the power of the computer device 120 alone is sufficient to keep operating the external mobile device 40 and perform data access in the external mobile device 40, and the effect of energy and carbon reduction can be attained.

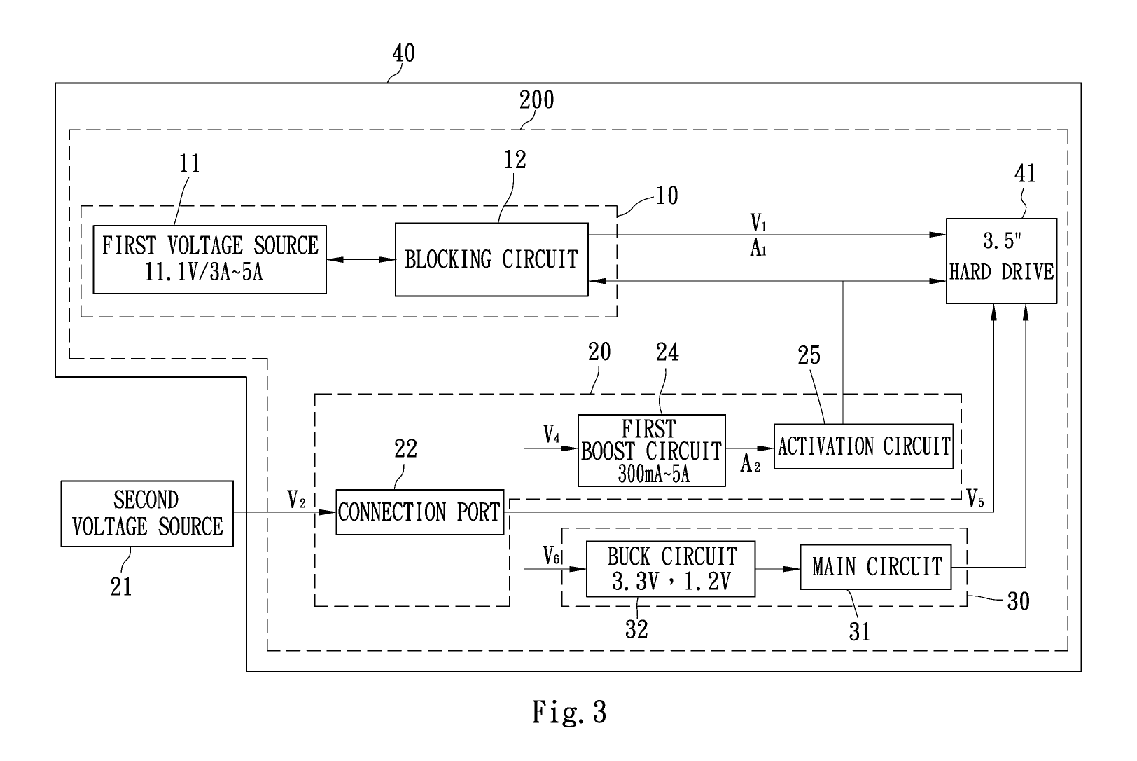

With reference to FIG. 3, a second embodiment of a structure 200 for providing power to external devices in accordance with the present invention has a first power supply module 10, a second power supply module 20 and a main circuit module 30.

The first power supply module 10 has a first voltage source 11 and a blocking circuit 12. The first voltage source 11 outputs a power with a voltage range of 11.1V to 11.7V and a current range of 3 A to 5 A. The first voltage source 11 is electrically connected to the blocking circuit 12 and outputs a power with a first output voltage V1 in a range of 11.1V to 11.7V and an activation current A1 in a range of 3V to 5V to activate a hard drive 41 (in particular a 3.5 inch hard drive) inside an external mobile device 40.

The second power supply module 20 has a connection port 22, a first boost circuit 24 and an activation circuit 25. The connection port 22 is a USB connection port and is electrically connected to the first boost circuit 24 to receive a second output voltage V₂. The second output voltage V₂ outputted from the connection port 22 is branched into a first voltage V₄, a second voltage V₅ and a third voltage V₆. The first voltage V₄ is outputted to the first boost circuit 24 and is boosted by the first boost circuit 24 to a voltage in a range of 11.7V to 12.58V or to a first operating current A₂ in a range of 300 mA to 5 A adjusted by the first boost circuit 24 depending on a resistance value of the first boost circuit 24. The second voltage V₅ is electrically connected the hard drive 41 inside the external mobile device 40. The first boost circuit 24 is further electrically connected to the activation circuit 25. The activation circuit 25 is electrically connected to the hard drive 41 of the external mobile device 40 and the block circuit 12. The first operating current A₂ is outputted from the activation circuit 25 to replace the activation current A₁ outputted from the first power supply module 10 for the purpose of stably supplying power to the hard drive or the CD/DVD drive inside the external mobile device 40. The second voltage V₅ is electrically connected to the hard drive 41 to supply a corresponding voltage and current to the hard drive 41.

The main circuit module 30 has a main circuit 31 and a buck circuit 32. The third voltage V6 is dropped through the buck circuit 32 to output a voltage approximately at 3.3V or 1.2V, which is further outputted to the main circuit 31.

The block circuit 12 of the first power supply module 10 is connected between the first voltage source 11 and the hard drive 41 of the external mobile device 40. When the external mobile device is powered off, the computer device 120 supplies no power to the external mobile device to keep its operation up and running and perform data access therein. The blocking circuit 12 blocks the first voltage source 11 to keep supplying power so as to reduce the power consumption of the first voltage source 1 and achieve an effect of energy and carbon reduction.

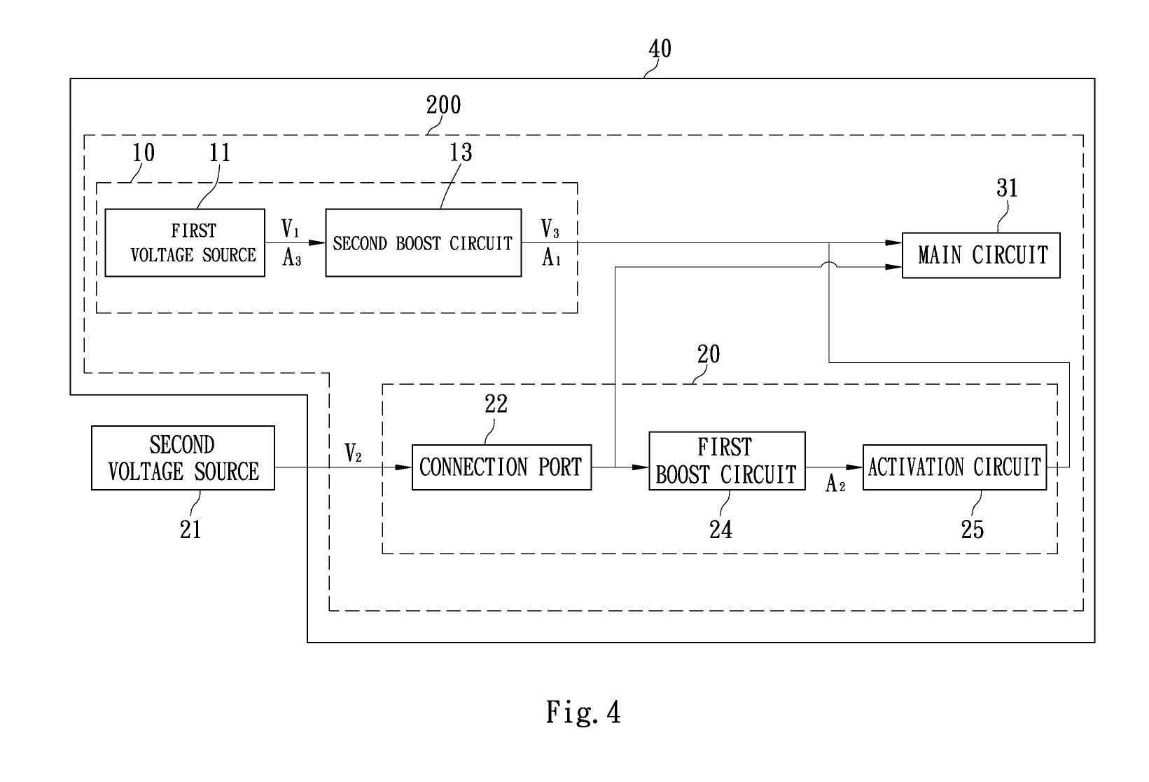

With reference to FIG. 4, a third embodiment of a structure 200 for providing power to external devices in accordance with the present invention has a first power supply module 10 and a second power supply module 20.

The first power supply module 10 has a first voltage source 11 and a second boost circuit 13. The first voltage source 11 may be a rechargeable DC battery 110, such as a lithium battery, a nickel-metal hydride battery, a lithium iron phosphate battery or the like. A first output voltage V₁ outputted from the first voltage source 11 ranges from 3.7V to 7.4V. The first voltage source 11 is electrically connected to the second boost circuit 13. The second boost circuit 13 boosts the first voltage V₁ to a voltage V₃ roughly in a range of 11.1V to 11.7V and outputs an activation current A₁ (a high transient load current) in a range of 3 A to 5 A to the main circuit 31 to activate the hard drive (in particular a 3.5 inch hard drive) inside the external mobile device 40.

The second power supply module 20 has a connection port 22, a first boost circuit 24 and an activation circuit 25. The connection port 22 is a USB connection port to receive a second output voltage V₂ outputted from a second voltage source 21. The first boost circuit 24 is electrically connected to an activation circuit 25 and a main circuit 31. The first boost circuit 24 boosts the second output voltage V₂ to a voltage ranging from 11.7V to 12.58V and supplies a current for operating the main circuit 31 and performing data access of the hard drive 41 in the external mobile device 40 to replace the activation current A₁ of the first power supply module 10 and charge the first voltage source 11.

With the structure for providing power to external mobile devices formed by the foregoing elements, when the first output voltage V₁ outputted from the first voltage source 11 falls in a range of 3.7V to 7.4V, the second boost circuit 13 boosts the first output voltage V₁ to a voltage in a range of 11.1V to 11.7V and outputs a high transient load current to the main circuit 31. The activation circuit 25 is further electrically connected to the hard drive 41 inside the external mobile device 40. A first operating current A₂ is outputted from the activation circuit 25 to replace the activation current A₁ outputted from the first power supply module 10 and to stably supply power to the hard drive or the CD/DVD drive inside the external mobile device 40. The rechargeable DC battery 110 may be one 3.7V battery or two 7.4V batteries connected in series, and can be repeatedly charged and operated.

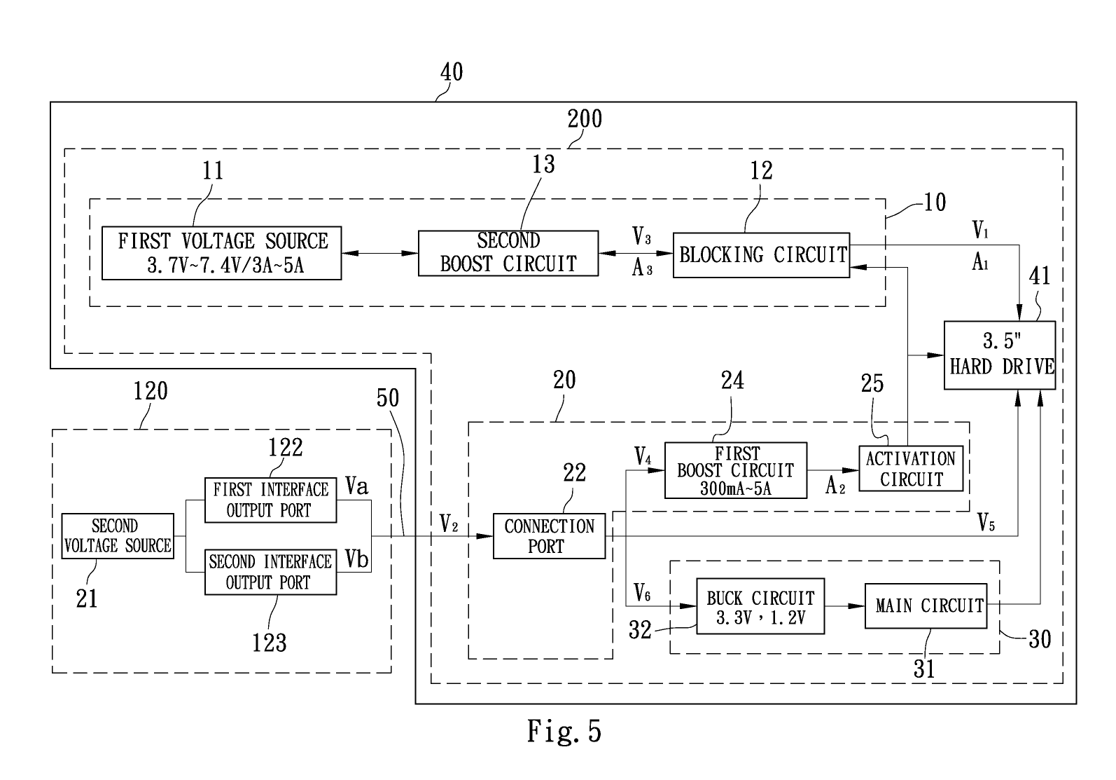

With reference to FIG. 5, a fourth embodiment of a structure 200 for providing power to external devices in accordance with the present invention has a first power supply module 10 and a second power supply module 20.

The first power supply module 10 has a first voltage source 11, a blocking circuit 12 and a second boost circuit 13. The first voltage source 11 outputs a first output voltage V₁ in a range of 3.7V to 7.4V, and is connected to the second boost circuit 13 so that the first output voltage V₁ is boosted by the second boost circuit 13 to a third output voltage V₃ in a range of 11.1V to 11.7V or a second operating current A₃. The second boost circuit 13 is electrically connected to the blocking circuit 12. An activation current A₁ is outputted from the blocking circuit 12 and has a high transient load current in a range of 3 A to 5 A. The blocking circuit 12 is electrically connected to a 3.5 inch hard drive 41. The activation current A₁ serves to activate the 3.5 inch hard drive 41 inside an external mobile device 40.

The second power supply module 20 has a connection port 22, a first boost circuit 24 and an activation circuit 25. The connection port 22 is a USB connection port and is electrically connected to the first boost circuit 24 for outputting a second output voltage V₂. The second output voltage V₂ outputted from the connection port 22 is branched into a first voltage V₄, a second voltage V₅ and a third voltage V₆. The first voltage V₄ outputted to the first boost circuit 24 is boosted by the first boost circuit 24 to a voltage in a range of 11.7V to 12.58V or a first operating current A₂ in a range of 300 mA to 5 A adjusted by the first boost circuit 24 depending on a resistance value of the first boost circuit 24. The second voltage V₅ is electrically connected to the hard drive 41 inside the external mobile device 40. The first boost circuit 24 is further electrically connected to the activation circuit 25 so that the first voltage V₄ can be further transmitted to the activation circuit 25. The activation circuit 25 is electrically connected to the hard drive 41 of the external mobile device 40 and the block circuit 12. The first voltage V₄ is outputted from the activation circuit 25 to replace the activation current A₁ outputted from the first power supply module 10 for the purpose of stably supplying power to the hard drive or the CD/DVD drive inside the external mobile device 40. The second voltage V₅ is electrically connected to the hard drive 41 inside the external mobile device 40.

The main circuit module 30 has a main circuit 31 and a buck circuit 32. The third voltage V₆ is dropped by the buck circuit 32 to output a voltage approximately at 3.3V or 1.2V, which is further outputted to the main circuit 31.

Operation of the structure 200 for providing power to external mobile devices having the foregoing elements is described as follows. With further reference to FIG. 2, when a USB Y-shaped transmission line 50 is plugged in the first interface output port 122 and the second interface output port 123 of the computer device 120, the first interface output port 122 and the second interface output port 123 respectively output a first input voltage Va and a second input voltage Vb to the USB connection port 22 on the second power supply module 20 and the first input voltage Va and a second input voltage Vb are merged into the second output voltage V₂. The second output voltage V₂ coming from the USB connection port 22 is branched into a first voltage V₄, a second voltage V₅ and a third voltage V₆. The first voltage V₄ is outputted to the first boost circuit 24 and is boosted by the first boost circuit 24 to a voltage in a range of 11.7V to 12.58V or to a current roughly in a range of 300 mA to 5 A adjusted by the first boost circuit 24. The first boost circuit 24 is electrically connected to the activation circuit 25. The activation circuit 25 is further electrically connected to the hard drive 41 inside the external mobile device 40 and the blocking circuit 12. The activation circuit 25 serves to output the first voltage V₄ to replace the activation current A₁ supplied by the first power supply module 12 so as to stably supply power to the hard drive or CD/DVD drive inside the external mobile device 40. The second voltage V₅ is electrically connected to the hard drive 41 inside the external mobile device 40. The third voltage V₆ is electrically connected to the main circuit 31 through the buck circuit 32 to provide the voltage and current required for operation of the main circuit 32 and for data access and backup of the 3.5 inch hard drive 41. Hence, a USB Y-shaped transmission line 50 is the only item required to be carried with the external mobile device 40 so that the hard drive 41 inside the external mobile device 40 can receive power outputted from the computer device 120 through the USB Y-shaped transmission line 50 and can be continuously operated for data access without requiring power from any external power source, transformer or 12V power supply to indeed have higher portability and operational convenience. When the power supplied to the external mobile device 40 through the USB Y-shaped transmission line 50 is stopped, the blocking circuit 12 that is electrically connected to the second boost circuit 12 blocks the second boost circuit 13 and the first voltage source 11 being a rechargeable DC battery 110, and stops supplying power from the rechargeable DC battery 110 to prolong the life cycle of the rechargeable DC battery 110. Meanwhile, the first operating current A₂ outputted from the activation circuit 25 can constantly drive the 3.5 inch hard drive 41 and charge the first voltage source 11. The rechargeable DC battery 110 can be charged multiple times and has higher level of environmental protection than disposable batteries for one-time use.

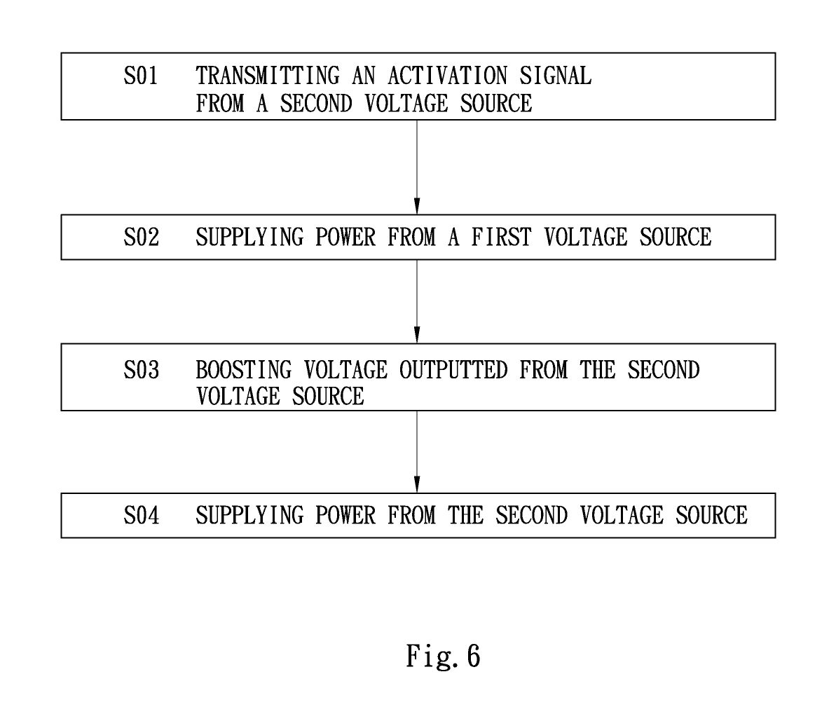

With reference to FIGS. 2 and 6, a first embodiment of a method for providing power to external mobile devices in accordance with the present invention has the following steps.

Step S01: Transmits an activation signal from a second voltage source. The second voltage source outputs the activation signal to a main circuit of an external mobile device through a connection port.

Step S02: Supply power from a first voltage source. After the main circuit receives the activation signal, the first voltage source outputs a first output voltage V₁ and an activation current A₁. The first voltage source outputs a voltage in a range of 11.1V to 11.7V or a transient load current in a range of 3 A to 5 A.

Step S03: Boost voltage outputted from the second voltage source. The voltage outputted from the second voltage source is boosted through a first boost circuit and a first operating current A₂ is outputted from the boost circuit to the main circuit. The voltage outputted from the first boost circuit ranges from 11.7V to 12.58V. The first operating current A2 is in a range of 300 mA to 400 mA.

Step S04: Supply power from the second voltage source. The first operating current A₂ flows through an activation circuit to replace the activation current A₁ outputted from the first voltage source for supplying power to the main circuit.

Given the foregoing steps of the method for providing power to external mobile devices, the second voltage source 21 transmits the activation signal to the main circuit 31 through the connection port, and the first voltage source 11 outputs a voltage in a range of 11.1V to 11.7V or a transient load current in a range of 3 A to 5 A to the main circuit 31 to activate a hard drive or a CD/DVD drive inside an external mobile device 40. When the second voltage source 21 outputs a second output voltage V₂ to a first boost circuit 24, the second output voltage V₂ is boosted to a voltage ranging from 11.7V to 12.58V and a first operating current A₂ is further transmitted to the activation circuit 25 to replace the activation current A₁ outputted from the first power supply module 10 so as to perform data access of the hard drive or the CD/DVD drive inside the external mobile device 40 connected to the main circuit 31 and charge the first voltage source 11. As no external power outlet or 12V power supply is required to supply power, desired portability can be achieved. The rechargeable DC battery can be charged for multiple uses and has higher level of environmental protection relative to disposable batteries for one-time use.

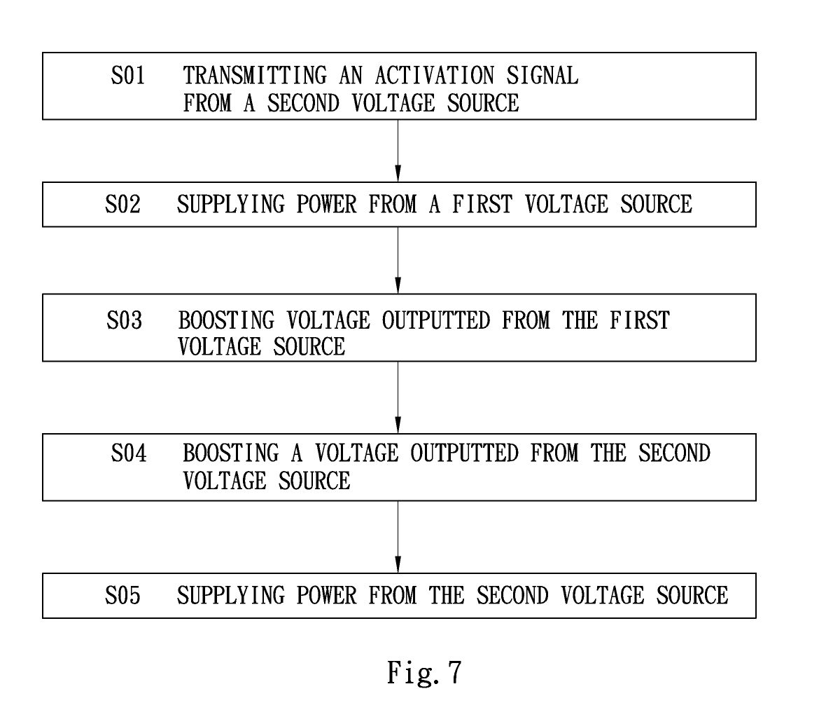

With reference to FIG. 7, a second embodiment of a method for providing power to external mobile devices in accordance with the present invention has the following steps.

Step S01: Transmits an activation signal from a second voltage source. The second voltage source outputs the activation signal to a main circuit through a connection port.

Step S02: Supply power from a first voltage source. After the main circuit receives the activation signal, the first voltage source outputs a first output voltage V₁ and an activation current A₁. The first voltage source outputs a voltage in a range of 3.7V to 7.4V or a transient load current in a range of 3 A to 5 A to a second boost circuit.

Step S03: Boost voltage outputted from the first voltage source. The first output voltage V₁ outputted from the first voltage source is boosted by a second boost circuit to a third output voltage V₃ in a range of 3.7V to 7.4V or the activation current in a range of 3 A to 5 A.

Step S04: Boost voltage outputted from the second voltage source. The voltage outputted from the second voltage source is boosted through a first boost circuit and a first operating current A₂ is outputted from the boost circuit to the main circuit. The voltage outputted from the first boost circuit ranges from 11.7V to 12.58V. The first operating current A2 is in a range of 300 mA to 400 mA.

Step S05: Supply power from the second voltage source. The first operating current A₂ flows through an activation circuit to replace the activation signal A₁ outputted from the first voltage source for supplying power to the main circuit.

By outputting the power from the first voltage source with the voltage in the range of 3.7V to 7.4V or the transient load current in a range of 3 A to 5 A and further outputting the power with the voltage in the range of 11.1V to 11.7V and the activation current in the range of 3 A to 5 A generated by the second boost circuit to the main circuit 31, the hard drive or the CD/DVD drive inside the external mobile device 40 can be activated. One or two rechargeable DC batteries can be used for charging so as to keep the first voltage source compact and achieve desired portability.

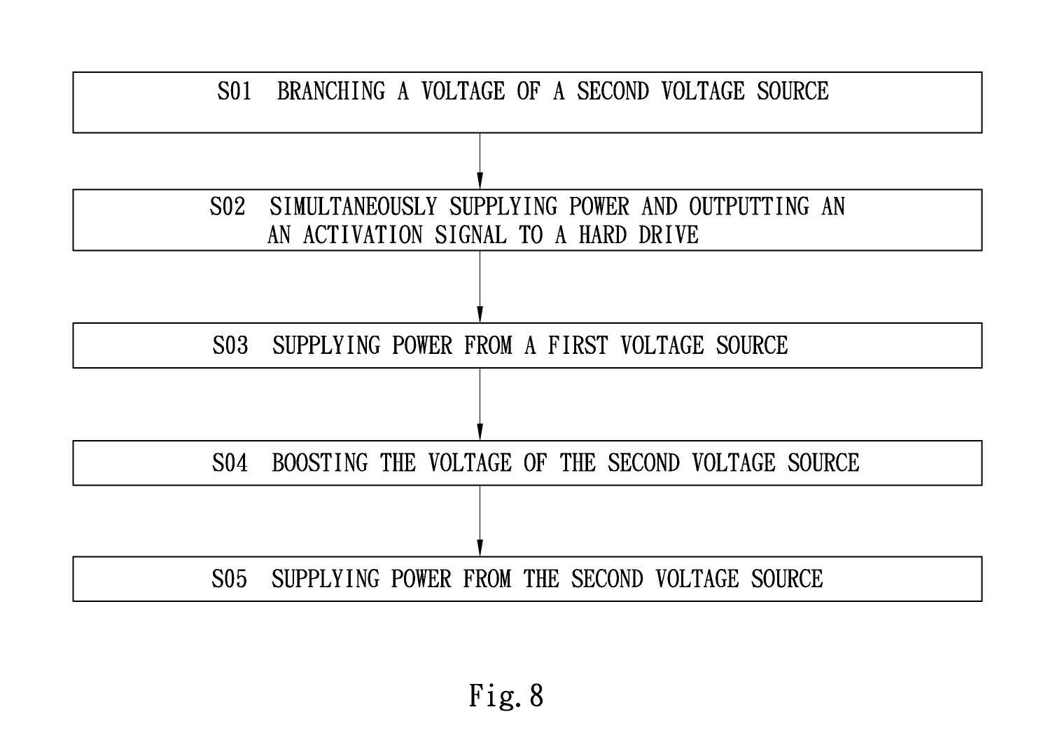

With reference to FIG. 8, a third embodiment of a method for providing power to external mobile devices in accordance with the present invention has the following steps.

Step S01: Branch a voltage of a second voltage source. The voltage of the second voltage source connected to a connection port is branched into a first voltage V₄, a second voltage V₅ and a third voltage V₆ to be further outputted.

Step S02: Supply power to a hard drive and simultaneously output an activation signal. The second voltage V₅ is supplied to the hard drive, the third voltage V₆ is supplied to a buck circuit and the third voltage V₆ is dropped to 3.2V or 1.2 V at the same time, and the activation signal is outputted to a main circuit and a hard drive connected to the main circuit.

Step S03: Supply power from a first voltage source. After the main circuit receives the activation signal, the first voltage source outputs a first output voltage V₁ and an activation current A₁ to the hard drive through a blocking circuit. Alternatively, the first voltage source first supplies power to a second boost circuit, a third output voltage V₃ or a current A₃ boosted by the second boost circuit is outputted to a blocking circuit, and then the first output voltage V₁ and the activation current A₁ generated through the blocking circuit is outputted to the hard drive.

Step S04: Boost the voltage of the second voltage source. The first voltage V₄ is boosted through a first boost circuit to output a first operating current A₂. The voltage outputted from the first boost circuit ranges from 11.7V to 12.58V. The first operating current A2 is in a range of 300 mA to 400 mA

Step S05: Supply power the second voltage source. The first operating current A₂ flows through an activation circuit to replace the activation current A₁ outputted from the first blocking circuit.

By outputting power from the first voltage source to the blocking circuit in generation of a first output voltage V₁ and the activation current A₁ and supplying the activation current A₁ to an external mobile device, a hard drive or a CD/DVD drive inside the external mobile device can be activated. When the second voltage supplying the external mobile device is shut off, the blocking circuit can block the first voltage source from supplying power, thereby achieving the effects of energy conservation and carbon reduction.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A structure for providing power to external mobile devices comprising:
a first power supply module having a first voltage source outputting a power with an activation current A₁ to a main circuit connected to an external mobile device; and
a second power supply module having:
an activation circuit; and
a boost circuit electrically connected to the activation circuit, adapted to receive and boost a second output voltage V₂ outputted from a second voltage source, and outputting a first operating current A₂ for replacing the activation current A₁ to supply power to the main circuit through the activation circuit.

2. The structure as claimed in claim 1, wherein the first voltage source is a rechargeable DC battery.

3. The structure as claimed in claim 2, wherein the rechargeable DC battery is a lithium battery, a nickel-metal hydride battery or a lithium iron phosphate battery.

4. The structure as claimed in claim 1, wherein the first power supply module further has a second boost circuit electrically connected to the second boost circuit further electrically connected to the main circuit and outputting the activation current A₁ to the main circuit.

5. A structure for providing power to external mobile devices comprising:
a first power supply module having:
a first voltage source; and
a blocking circuit electrically connected to the first voltage source;
a second power supply module having:
an activation circuit; and
a first boost circuit adapted to electrically connect to a second voltage source and electrically connected to the activation circuit; and
a main circuit module having:
a buck circuit; and
a main circuit adapted to electrically connect to the second voltage source through the buck circuit.

6. The structure as claimed in claim 5, wherein the first power supply module further has a second boost circuit electrically connected to the blocking circuit.

7. The structure as claimed in claim 6, wherein the second power supply module further has a connection port electrically connected to the first boost circuit.

8. The structure as claimed in claim 7, wherein the connection port receives a second output voltage V₂ from a computer device and the second output voltage V₂ is branched into a first voltage V₄, a second voltage V₅ and a third voltage V₆.

9. The structure as claimed in claim 8, wherein the first voltage V₄ is outputted to the first boost circuit and a first operating current A₂ outputted from the first boost circuit is adjustable in a range of 300 mA to 5 A.

10. The structure as claimed in claim 9, wherein the second voltage V₅ is outputted to an external mobile device.

11. The structure as claimed in claim 10, wherein the third voltage V₆ is dropped to a voltage at 3.3V or 1.2V through a buck circuit and is further outputted to the main circuit and a hard drive or a CD/VCD drive inside the external mobile device.

12. The structure as claimed in claim 11, wherein the second operating current A₂ is outputted to the activation circuit of the second power supply module, and the activation circuit is electrically connected to the hard drive or the CD/VCD drive of the external mobile device and the blocking circuit of the first power supply module.

13. The structure as claimed in claim 12, wherein the activation circuit serves to output the second output voltage V2 to replace the activation current A1 from the first power supply module so as to supply power to the hard drive or the CD/VCD drive inside the external mobile device.

14. A method for providing power to external mobile devices comprising steps of:
transmitting an activation signal from a second voltage source, wherein the second voltage source outputs the activation signal to a main circuit of an external mobile device through a connection port;
supplying power from a first voltage source, wherein after the main circuit receives the activation signal, the first voltage source outputs a first output voltage V₁ and an activation current A₁ to the main circuit.
boosting a voltage outputted from the second voltage source, wherein the voltage outputted from the second voltage source V₂ is boosted through a first boost circuit and a first operating current A₂ is outputted from the boost circuit;
supplying power from the second voltage source, wherein the first operating current A₂ flows through an activation circuit to replace the activation current A₁ outputted from the first voltage source.

15. The method as claimed in claim 14, wherein the first voltage source outputs a voltage in a range of 11.1V to 11.7V or a transient load current in a range of 3 A to 5 A.

16. The method as claimed in claim 15, wherein the second voltage source has a voltage in a range of 4.5V to 5.5V or a current in a range of 300 mA to 400 mA.

17. The method as claimed in claim 16, wherein the voltage outputted from the second voltage source V₂ is boosted to a voltage in a range of 11.7V to 12.58V or the first operating current A₂ in a range of 300 mA to 400 mA.

18. The method as claimed in claim 17, wherein the first voltage source outputs a voltage in a range of 3.7V to 7.4V or a transient load current in a range of 3 A to 5 A to a second boost circuit, and the voltage of the first voltage source is boosted by the second boost circuit to fall in a range of 11.1V to 11.7V.

19. A method for providing power to external mobile devices comprising steps of:
branching a voltage of a second voltage source, wherein the voltage of the second voltage source connected to a connection port is branched into a first voltage V₄, a second voltage V₅ and a third voltage V₆ to be further outputted;
simultaneously supplying power and outputting an activation signal to a hard drive, wherein the second voltage V₅ is supplied to the hard drive, and the third voltage V₆ is supplied to a buck circuit to drop the third voltage V₆ to 3.2V or 1.2 V at the same time, and the activation signal is outputted to a main circuit and a hard drive connected to the main circuit;
supplying power from a first voltage source, wherein after the main circuit receives the activation signal, the first voltage source outputs a first output voltage V₁ and an activation current A₁ to the hard drive through a blocking circuit;
boosting the voltage of the second voltage source, wherein the first voltage V₄ is boosted through a first boost circuit to output a first operating current A₂; and
supplying power from the second voltage source, wherein the first operating current A₂ flows through an activation circuit to replace the activation current A₁ outputted from the first blocking circuit.

20. The method as claimed in claim 19, wherein the third voltage V₆ dropped by the buck circuit to output a voltage at 3.3V or 1.2V to the main circuit and the hard drive.

21. The method as claimed in claim 20, wherein the first voltage source outputs a voltage in a range of 11.1V to 11.7V or a transient load current in a range of 3 A to 5 A.

22. The method as claimed in claim 21, wherein the second voltage source has a voltage in a range of 4.5V to 5.5V or a current in a range of 300 mA to 400 mA.

23. The method as claimed in claim 22, wherein the voltage outputted from the second voltage source V₂ is boosted to a voltage in a range of 11.7V to 12.58V or the first operating current A₂ in a range of 300 mA to 400 mA.

24. The method as claimed in claim 23, wherein the first voltage source outputs a voltage in a range of 3.7V to 7.4V or a transient load current in a range of 3 A to 5 A to a second boost circuit, and the voltage of the first voltage source is boosted by the second boost circuit to fall in a range of 11.1V to 11.7V.
